(19) United States
(12) Patent Application Publication
(10) Pub. No.: US 2026/0098597 A1
(43) Pub. Date: Apr. 9, 2026

(54) FITTING WITH SEQUENTIAL SEALING ACTION

(71) Applicant: LenLok Holdings, LLC, Willoughby, OH (US)

(72) Inventors: Mark John SINDELAR, Shaker Heights, OH (US); Alan Michael PEABODY, Willougby, OH (US); William LENNON, Willoughby, OH (US)

(21) Appl. No.: 18/910,784

(22) Filed: Oct. 9, 2024

(51) Int. Cl. F16L 3/02

(52) U.S. Cl. CPC F16L 13/146; F16L 13/007; F16L 3/02; F16L 19/10

(57) ABSTRACT

A fluid fitting for mechanical attachment to a fluid element includes a coupling body defining a bore for receiving the fluid element therein, the coupling body comprising a main seal, an inboard seal, an outboard seal, and a torsion ridge; and a drive ring configured to fit over the coupling body. The fluid fitting is configured to be installed on the fluid element by axially translating the drive ring over the coupling body with the fluid element inside the bore of the coupling body, thereby mechanically attaching the coupling body to the fluid element. Moreover, the fluid fitting is configured such that during installation the main seal and torsion ridge initiate deforming contact with the fluid element, and then the inboard seal and outboard seal initiate deforming contact the fluid element.

### FIELD OF THE DISCLOSURE

The present disclosure generally relates to a fluid fitting and, more particularly, to an improved fitting with sequential sealing action.

### BACKGROUND

Various types of fittings have been developed for joining tubes and pipes to other tubes and pipes, or to other fluid apparatus such as pumps, fluid motors, actuation cylinders, etc. For thin-walled tubing or pipe, various types of fittings are used which compress against the outside diameter of the tube or pipe to create a seal. One particular type of such a fitting includes a drive ring which is forced over a coupling body to compress it radially inwardly against the tube or pipe to create a seal. Generally, this type of fitting has one or more circumferential coupling elements (e.g., teeth or ridges) on the inside diameter of its coupling body which, when compressed inwardly by a drive ring, engage the outside diameter of the tube or pipe to create one or more leak-tight mechanical connections or joints between the tube or pipe and the fitting. This engagement of the coupling elements of the fitting with the tube or pipe causes the pipe to be deformed radially inwardly, with the coupling body of the fitting located externally about the tube or pipe.

Examples of such mechanically attached fittings are provided in U.S. Pat. Nos. 4,482,174; 5,110,163; 5,114,191; 6,692,040; and 7,575,257. One example installation tool employable for attaching these types of fittings to a tube or pipe is described in U.S. Pat. No. 5,305,510. All the teachings and substance of these patents are hereby expressly incorporated by reference into the present application.

The types of fittings described in the preceding paragraphs are often designed so that the coupling elements sequentially engage the tube or pipe upon which the fitting is being installed. Such sequential engagement reduces the installation force required to move the drive ring from an outboard configuration to a fully installed inboard configuration. This is due to the installation tool only being required to provide enough force to do the work necessary to cause deformation, and thus engagement with the tube or pipe, at one coupling element location at a time. Performing the fitting installation at two or more coupling element locations simultaneously would require more force as more work would have to be done per increment of travel of the drive ring.

Sometimes the sealing ability of a fitting can be diminished, particularly as a consequence of two factors: (1) sequential tooth or seal engagement; and (2) pipe radial deformation. For example, engagement of a second sealing tooth subsequent to engagement of a first sealing tooth, and the attendant pipe deformation caused by the subsequent engagement, may reduce the loading force between the first sealing tooth and the tube or pipe. In this example, the loading force reduction due to the subsequent engagement of the second tooth results from the pipe being pushed away from the first tooth. In an extreme case, this may result in a gap being formed between the first sealing tooth and the tube or pipe and/or may result in diminished effectiveness of the seal between the first sealing tooth and the tube or pipe, particularly under the influence of an applied mechanical load such as bending and torsion.

The Applicant of this application manufactures, sells and/or distributes a variety of such sequential fittings. These fittings often include three (3) circumferential teeth or ridges, typically referred to as seals, including a main seal, an inboard seal, and an outboard seal. As already discussed, the seals extend radially inward from an inside diameter of the fitting's coupling body and are compressed inwardly by a drive ring axially installed on an outside diameter of the coupling body to create a leak-tight mechanical connections or joints between each seal and a tube or pipe received inside the coupling body to which the fitting is being connected. The engagement of the seals with the tube or pipe causes the same to be plastically deformed radially inward at the location of engagement with the seals.

The particular configuration of the coupling body and/or the drive ring often determines the order in which the seals (including the main, inboard, and outboard seals) are forced into deforming contact with the tube or pipe. Accordingly, an issue to be addressed is that of obtaining the optimal benefit of sequential engagement of the sealing teeth, particularly in a fitting wherein a main seal, an inboard seal, and an outboard seal are provided, while reducing or eliminating any associated reduction of load force on the sealing teeth that were engaged early in the engagement sequence.

### SUMMARY

In accordance with one aspect, a fluid fitting for mechanical attachment to a fluid element includes a coupling body defining a bore for receiving the fluid element therein, the coupling body comprising a main seal, an inboard seal, an outboard seal, and a torsion ridge; and a drive ring configured to fit over the coupling body. The fluid fitting is configured to be installed on the fluid element by axially translating the drive ring over the coupling body with the fluid element inside the bore of the coupling body, thereby mechanically attaching said coupling body to the fluid element. Moreover, the fluid fitting is configured such that during installation the main seal and torsion ridge initiate deforming contact with the fluid element, and then the inboard seal and outboard seal initiate deforming contact the fluid element.

### BRIEF DESCRIPTION OF THE DRAWINGS

FIG. 1 is a cross-sectional view of an example fitting having a coupling body and a drive ring for connecting the coupling body to a fluid element (e.g., pipe);

FIG. 2 is an enlarged partial cross-sectional view of the coupling body;

FIG. 3 is an enlarged partial cross-sectional view of the drive ring;

FIG. 4 is partial cross-sectional view of the fitting at a first stage in an installation process, wherein the fitting assumes a preinstalled configuration with the fluid element extending into a bore of the coupling body;

FIG. 5 is partial cross-sectional view of the fitting at a second stage in the installation process, wherein the drive ring has moved axially along an inboard direction from its position in FIG. 4;

FIG. 6 is partial cross-sectional view of the fitting at a third stage in the installation process, wherein the drive ring has moved axially along the inboard direction from its position in FIG. 5;

FIG. 7 is partial cross-sectional view of the fitting at a fourth stage in the installation process, wherein the drive ring has moved axially along the inboard direction from its position in FIG. 6;

FIG. 8 is partial cross-sectional view of the fitting at a fifth stage in the installation process, wherein the drive ring has moved axially along the inboard direction from its position in FIG. 7; and

FIG. 9 is partial cross-sectional view of the fitting at a final stage in the installation process, wherein the drive ring has moved axially along the inboard direction from its position in FIG. 8, such that the fitting assumes an installed configuration.

### DETAILED DESCRIPTION

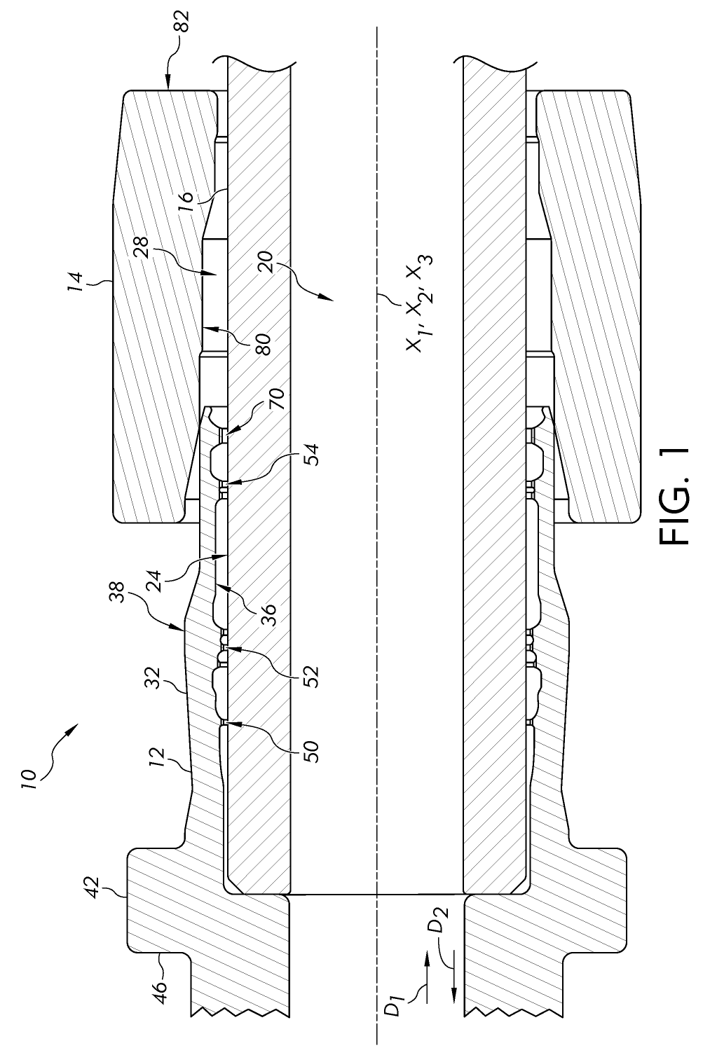

Turning to FIG. 1, an example fluid fitting 10 includes a coupling body 12 and a drive ring 14, which together can be utilized to join a fluid element 16 to the fluid fitting 10. The fluid element 16 in the present example is a pipe having a passageway 20 for conveying fluid. Moreover, the coupling body 12 defines a bore 24 that can receive the fluid element 16 therein to place the coupling body 12 and fluid element 16 in fluid communication with each other. The drive ring 14 defines a through hole 28 that, as discussed further below, can accommodate the coupling body 12 therein to mechanically attach the coupling body 12 to the fluid element 16 in a non-leaking manner.

In one operative example, the coupling body 12 and the drive ring 14 are formed of stainless steel, while the fluid element 16 is formed of 70/30 Copper Nickel. As will be appreciated and understood by those skilled in the art, the coupling body 12 and drive ring 14 could alternately be formed of any of a variety of other fitting materials including, for example carbon steel, 90/10 copper nickel, 70/30 copper nickel, etc. Likewise, the fluid element 16 could be formed of a variety of other materials. In one embodiment, the fluid element 16 is one of a schedule 10 type pipe through a schedule 80 type pipe and has a wall thickness between about 0.057 inches to about 0.261 inches or is outside diameter-dimensioned tubing with wall thicknesses ranging from 0.035 inches through 0.109 inches. The fluid element 16 can be any structure that defines a passageway for conveying fluid. For instance, the fluid element 16 can be a tube, manifold, fluid connector, nozzle, or any combination thereof.

The passageway 20, bore 24, and through hole 28 of the components 12, 14, 16 have respective central axes X₁, X₂, X₃, which are aligned to be coaxial with each other in FIG. 1. It is to be appreciated that the features of each component 12, 14, 16 in the present embodiment generally extend circumferentially and symmetrically about the component’s respective axis X₁, X₂, X₃. Moreover, as used herein, the terms “axial”, “radial”, and the like when describing features of a component 12, 14, 16 are relative to the component’s central axis X₁, X₂, X₃. Meanwhile, the terms “proximal”, “distal”, “inboard”, “outboard”, and the like are used to indicate relative axial spacing along the component’s central axis X₁, X₂, X₃. For example, the axial direction D₁ in FIG. 1 corresponds to an outboard or distal direction for each component 12, 14, 16, while the axial direction D₂ corresponds to the inboard or proximal direction for each component 12, 14, 16.

The coupling body 12 comprises a sleeve 32 having an inner surface 36 and an outer surface 38. The inner surface 36 of the sleeve 32 defines the bore 24 of the coupling body 12. Moreover, the coupling body 12 comprises a circumferential flange 42 that extends radially outward from the outer surface 38 of the sleeve 32. The flange 42 defines a tool engaging surface 46, which extends in the radial direction and can be used by an external installation tool to join the fluid fitting 10 to the fluid element 16, as described later herein.

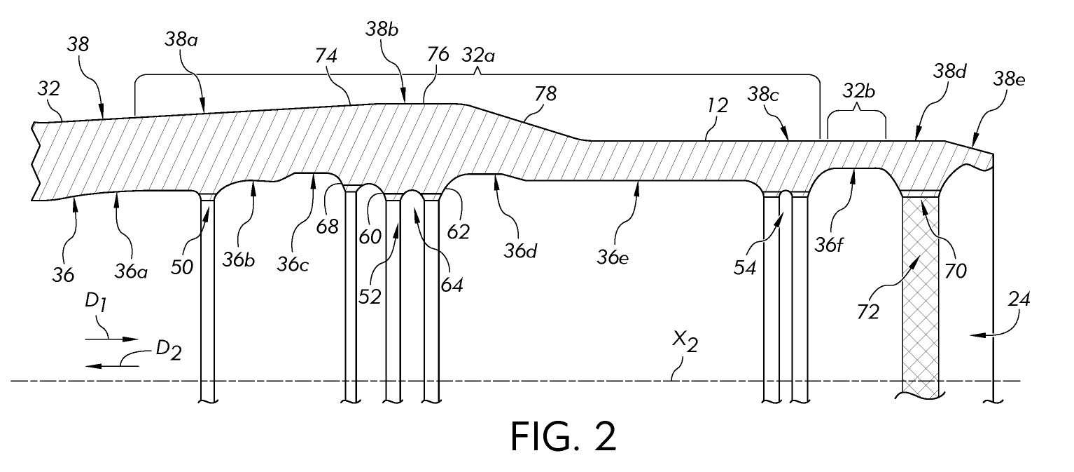

With additional reference to FIG. 2, the sleeve 32 includes a plurality of circumferential seals 50, 52, 54 formed by the inner surface 36, including an inboard or proximal seal 50, a main seal 52, and an outboard or distal seal 54. Each seal 50, 52, 54 can comprise one or more teeth that extend radially inward from neighboring portions of the inner surface 36 for sealing between and mechanically connecting the coupling body 12 to the fluid element 16. For example, in the present embodiment, the main seal 52 comprises a pair of twin teeth 60, 62 slightly separated by an annular groove 64, together with an inboard tooth 68 that is proximal to the twin teeth 60, 62. The lands of the twin teeth 60, 62 are substantially similar in diameter, whereas the land of the inboard tooth 68 has a relatively larger diameter such that it is located radially outward from the lands of the twin teeth 60, 62.

The sleeve 32 also includes a circumferential anti-torsion ridge 70 (also referred to herein as a torsion ridge) that is located distal to the outboard seal 54 and is provided to resist torsion loads between the coupling body 12 and fluid element 16. The torsion ridge 70 likewise extends radially inward from neighboring portions of the inner surface 36, and preferably has friction surfaces 72 formed on its land (e.g., by knurling, broaching, or the like) to better resist torsion loads between the coupling body 12 and the fluid fitting 16.

The inner surface 36 of the sleeve 32 includes various sections 36a-f that extend from the roots of the seals 50, 52, 54 and torsion ridge 70. For example, the inner surface 36 includes a tapered section 36a that extends inboard from the seal 50 and gradually decreases in diameter in the inboard direction D₂, and a diametrically constant section 36b that extends outboard from the seal 50. The inner surface 36 further includes a tapered section 36c that extends inboard from the seal 52 and gradually decreases in diameter in the inboard direction D₂, and a tapered section 36d that extends outboard from the seal 52 and gradually decreases in diameter in the outboard direction D₁. Finally, the inner surface 36 includes diametrically constant sections 36e, 36f that respectively extend inboard and outboard from the seal 54. The diametrically constant section 36f extends to the root of the torsion ridge 70.

The outer surface 38 of the sleeve 32, meanwhile, has various sections 38a-e that are aligned opposite to associated features of the inner surface 36. In particular, the outer surface 38 includes a tapered section 38a that is immediately opposite to the inboard seal 50 and gradually increases in diameter in the outboard direction D₁. The outer surface 38 further includes a rounded section 38b that is immediately opposite to the main seal 52 and comprises a gradually upsloping ramp 74, a plateau 76, and a gradually downsloping ramp 78. The outer surface 38 further includes diametrically constant sections 38c, 38d that are immediately opposite to the outboard seal 54 and torsion ridge 70, respectively. Finally, the outer surface 38 includes a tapered section 38e that extends outboard from section 38d that gradually decreases in diameter in the outboard direction D₁.

As can be seen in FIG. 2, the sleeve 32 has a thickness (measured in the radial direction) that varies along the central axis X₂. In particular, the sleeve 32 includes a first sleeve portion 32a that forms the seals 50, 52, 54 and is larger in thickness than a second sleeve portion 32b located axially between the outboard seal 54 and torsion ridge 70. Put another way, a minimum thickness of the second sleeve portion 32b is less than a minimum thickness of the first sleeve portion 32a. As discussed later herein, this difference in minimum thickness can facilitate radial deformation of the torsion ridge 70 relative to the outboard seal 54.

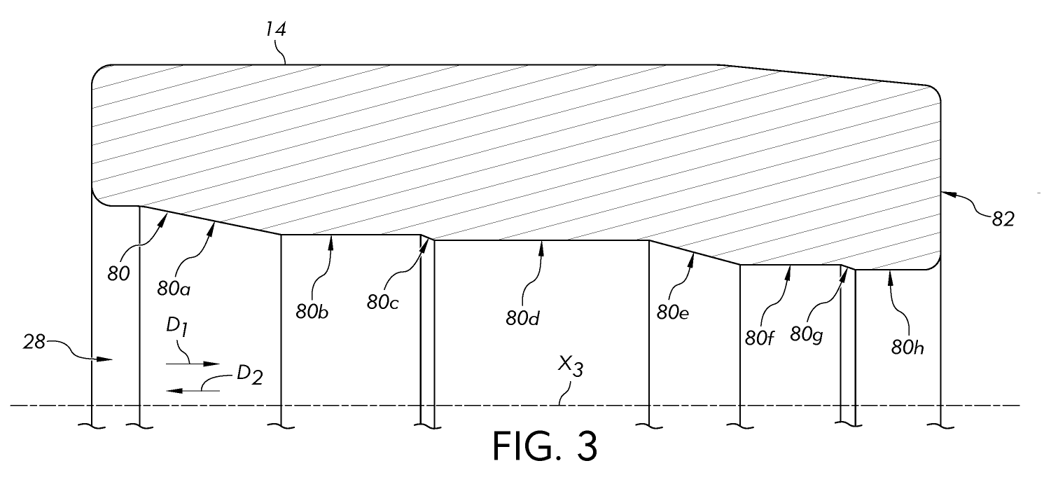

With additional reference to FIG. 3, the drive ring 14 includes an inner surface 80 that defines its through hole 28 and has a series of tapered or diametrically constant surface sections 80a-h. In particular, the inner surface 80 includes a proximal tapered section 80a; a diametrically constant section 80b that extends distally from the proximal tapered section 80a; a tapered section 80c that extends distally from the diametrically constant section 80b; a diametrically constant section 80d that extends distally from the tapered section 80c; a tapered section 80e that extends distally from the diametrically constant section 80d; a diametrically constant section 80f that extends distally from the tapered section 80e; a distal tapered section 80g that extends distally from the diametrically constant section 80f; and a diametrically constant section 80h that extends distally from the tapered section 80g. The tapered sections 80a, 80c, 80e, 80g all gradually decrease in diameter in the outboard direction D₁.

The drive ring 14 also includes a tool engaging surface 82 on its distal end for engagement with the external installation tool, which extends in the radial direction and can be used to join the fluid fitting 10 to the fluid element 16, as described later herein.

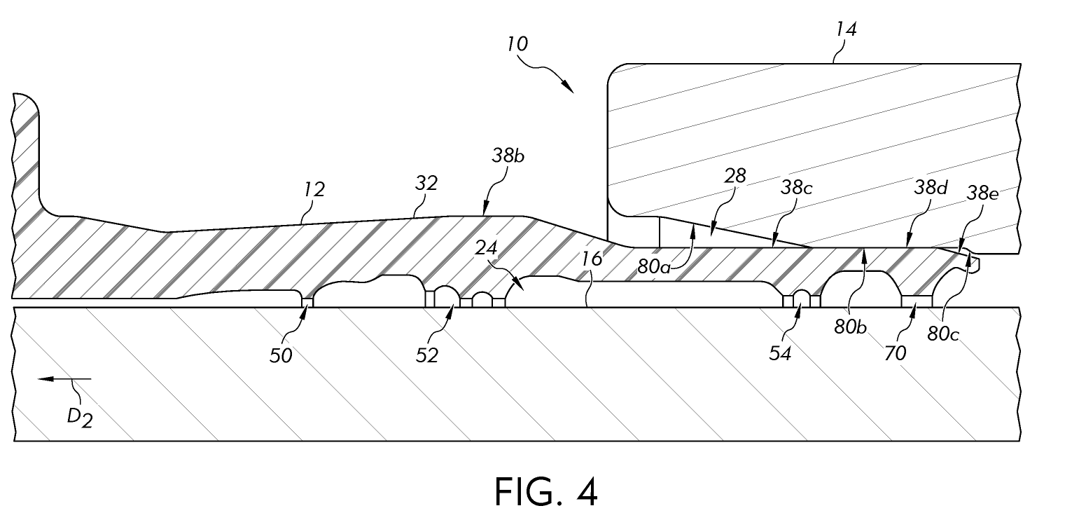

With additional reference to FIG. 4, the coupling body 12 and drive ring 14 are shown in a preinstalled configuration, in which their central axes are substantially aligned and the coupling body 12 is partially received within the through hole 28 of the drive ring 14. In this configuration, the tapered surface section 38e of the coupling body 12 is adjacent but slightly spaced relative to the tapered surface section 80c of the drive ring 14. Moreover, the diametrically constant surface sections 38d, 80b of the coupling body 12 and drive ring 14 engage each other to establish an interference fit.

Specifically, the diameter of drive ring surface section 80b is slightly smaller than the diameter of the coupling body surface section 38d so that the interference fit is formed when the drive ring 14 is axially forced onto the coupling body 12 to the preinstalled configuration of FIG. 4. This causes the sleeve 32 to partially contract radially. However, a sufficient inner diameter is maintained for all the seals 50, 52, 54 and the torsion ridge 70 so that the fluid element 16 can be inserted into the bore 24 of the coupling body 12. The sufficient inner diameter is large enough to accommodate a manufacturing tolerance of the coupling body 12, to accommodate a manufacturing tolerance of the fluid element 16, and to maintain a clearance gap between the sleeve 32 and the fluid element 16 that allows relatively easy insertion of the fluid element 16 into the bore 24.

Through the interference fit, the fitting 10 can be maintained and shipped to customers in the preinstalled configuration, which facilitates ease of use and installation by the ultimate end-users. In particular, ease of use is facilitated by the fitting 10 being maintained as a partially assembled one-piece assembly, as opposed to the components of the assembly being multiple pieces separate from one another.

An installation process of the fitting 10 onto the fluid element 16 will now be described. As shown in FIG. 4, with the fitting 10 in its preinstalled configuration, the fluid element 16 can be inserted into the bore 24 of the coupling body 12 along the inboard direction D₂ such that the fluid element 16 extends through the torsion ridge 70 and all seals 50, 52, 54 of the coupling body 12. Notably, the central axes of the coupling body 12, drive ring 14, and fluid element 16 are substantially aligned in FIG. 4 and will remain substantially aligned through the installation process. Moreover, the torsion ridge 70 and seals 50, 52, 54 do not make deforming contact with the fluid element 16 in FIG. 4 (i.e., the torsion ridge 70 and seals 50, 52, 54 do not deform the fluid element 16).

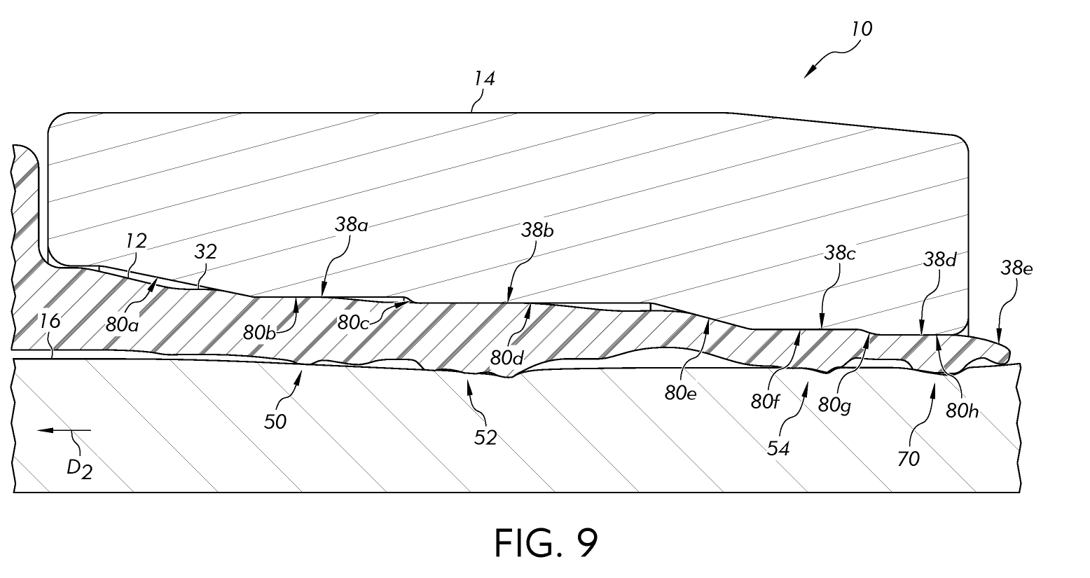

An external installation tool (not shown) can then be used to axially force the drive ring 14 along the coupling body 12 in the inboard direction D₂. One suitable installation tool is described in commonly-owned U.S. Pat. No. 5,305,510, expressly incorporated herein by reference. As will be known and appreciated by those skilled in the art, the installation tool has opposed jaws that can engage the tool engaging surface sections 46, 82 (see FIG. 1) of the coupling body 12 and drive ring 14 and be actuated to force or press the drive ring 14 toward the coupling body 12 via a clamping action along the inboard direction D₂ until the fitting 10 assumes an installed configuration shown in FIG. 9.

As will be described in more detail below, the fitting 10 is configured so that axial movement of the drive ring 14 from the preinstalled configuration in FIG. 4 to the installed configuration in FIG. 9 causes the inner surface section 80 of the drive ring 14 to radially contract the sleeve 32 of the coupling body 12, such that the coupling elements (i.e., seals 50, 52, 54 and torsion ridge 70) of the coupling body 12 engage and mechanically attach to the fluid element 16. More particularly, the coupling elements 50, 52, 54, 70 will move radially inward and bite into the fluid element 16. The fluid element 16 typically becomes stressed beyond its elastic limit as the coupling elements 50, 52, 54, 70 move thereinto, and begins to plastically deform or move radially inward, resulting in permanent deformation of the fluid element 16. When deforming the fluid element 16, the seals 50, 52, 54 are typically compressed or squished, causing tooth deformation which has the advantage of filling any rough or irregular surface section imperfections adjacent the teeth. Moreover, the biting of each coupling element 50, 52, 54, 70 into the fluid element 16 can be accompanied by some growth, typically in elastic form, of the drive ring 14.

The fluid fitting 10 is further configured such that the coupling elements 50, 52, 54, 70 will sequentially engage the fluid element 16 in a preferred order in order to minimize the load force required to move the drive ring 14 from the preinstalled configuration in FIG. 4 to the installed configuration in FIG. 9. Preferably, the coupling elements 50, 52, 54, 70 will be set one at a time, such that no more than one or two coupling elements 50, 52, 54, 70 is/are actively setting at any point during the installation process.

Setting of a coupling element 50, 52, 54, 70 means that the drive ring 14 is actively forcing the coupling element 50, 52, 54, 70 into deforming contact with the fluid element 16, such that further axial movement of the drive ring 14 in the inboard direction D₂ will continue driving the coupling element 50, 52, 54, 70 further into the fluid element 16. Thus, for the purpose of this disclosure, a coupling element 50, 52, 54, 70 is considered “set” into the fluid element 16 when it is in deforming contact with the fluid element 16 and further axial movement of the drive ring 14 in the inboard direction D₂ will not (at least immediately) drive the coupling element 50, 52, 54, 70 further into the fluid element 16. For example, a surface section 38a-d of the coupling body 12 immediately opposite the coupling element 50, 52, 54, 70 may be engaged and radially aligned with a diametrically constant surface section 80b, 80d, 80f, 80h of the drive ring 14, such that further axial movement of the drive ring 14 in the inboard direction D₂ will not continue driving the coupling element 50, 52, 54, 70 radially inward into the fluid element 16.

Notably, a coupling element 50, 52, 54, 70 can be initially “set” for a certain portion of the drive ring’s axial movement and then resume a final “setting” if later movement of the drive ring 14 in the inboard direction D₁ forces the coupling element 50, 52, 54, 70 further into the fluid element 16. Moreover, although the coupling elements 50, 52, 54, 70 will preferably be set one at a time, it is to be appreciated that the setting of some coupling elements 50, 52, 54, 70 may overlap in some embodiments.

The sequential engagement of the coupling elements 50, 52, 54, 70 will now be described in more detail with reference to FIGS. 4-9, which show the fitting 10 at various stages from its preinstalled configuration in FIG. 4 to its installed configuration in FIG. 9.

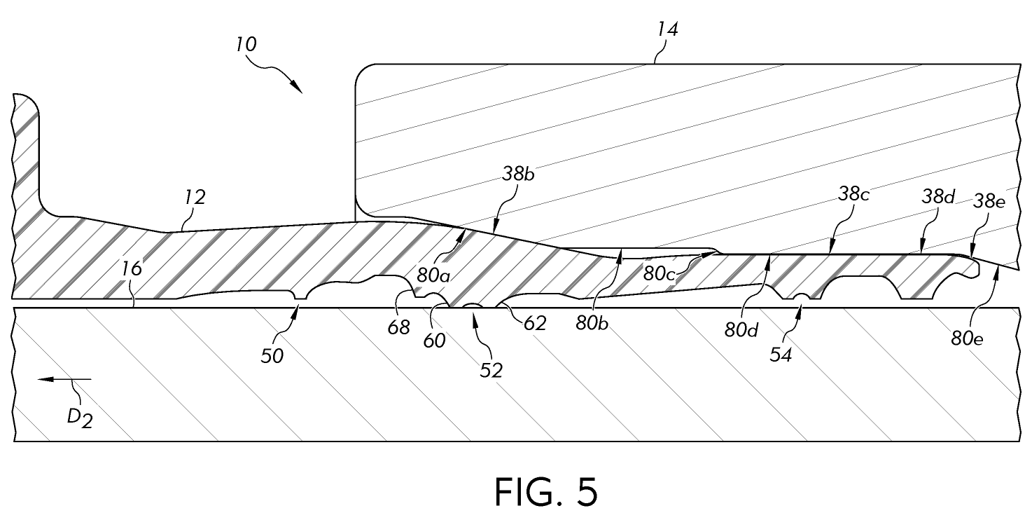

As discussed above, an external installation tool (not shown) can be used to axially force the drive ring 14 from its position in FIG. 4 toward the coupling body 12 in the inboard direction D₂. As the drive ring 14 is axially forced along the coupling body 12, the fitting 10 will next assume the state shown in FIG. 5. Specifically, the tapered surface section 80c of the drive ring 14 will deflect the coupling body surface sections 38c, 38d (and the opposing outboard seal 54 and torsion ridge 70) radially inward such that the coupling body surface sections 38c, 38d engage and pass under the diametrically constant surface section 80d of the drive ring 14. Meanwhile, the tapered surface section 80a of the drive 14 will deflect the coupling body surface section 38b and opposing main seal 52 radially inward such that the twin teeth 60, 62 of the main seal 52 initiate deforming contact with the fluid element 16, thereby initiating a setting process for the main seal 52. At this stage, the torsion ridge 70, inboard seal 50, and outboard seal 54 do not make deforming contact with the fluid element 16, thus minimizing the load required to axially force the drive ring 14.

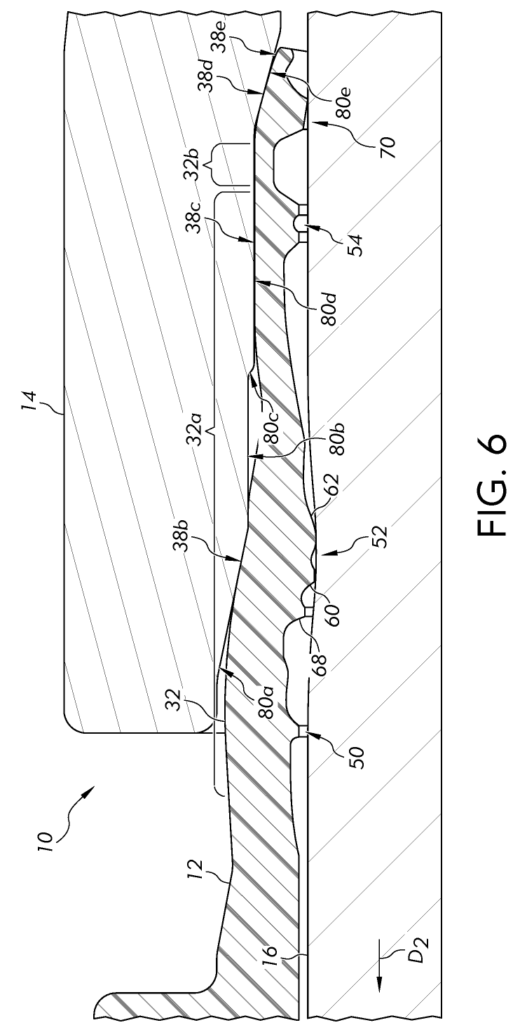

As the drive ring 14 continues axial movement in the inboard direction D₂, the fitting 10 will next assume the state shown in FIG. 6. Specifically, the tapered surface section 80e of the drive ring 14 will deflect the coupling body surface section 38d (and the opposing torsion ridge 70) radially inward such that the torsion ridge 70 initiates deforming contact with the fluid element 16, thereby initiating a setting process for the torsion ridge 70. As noted above, the second sleeve portion 32b between the outboard seal 54 and torsion ridge 70 has a minimum thickness that is less than minimum thickness of the first sleeve portion 32a that forms the seals 50, 52, 54. This difference in minimum thickness can facilitate bending of the second sleeve portion 32b relative to the first sleeve portion 32a, such that the torsion ridge 70 can deflect radially inward while the outboard seal 54 remains spaced from and does not deformably contact the fluid element 16.

In the present embodiment, the tapered surface section 80a of the drive ring 14 will continue deflecting the coupling body surface section 38b and opposing main seal 52 as the torsion ridge 70 initiates deforming contact with the fluid element 16. In other words, setting of the main seal 52 will continue and overlap with setting of the torsion ridge 70. However, loading force for the drive ring 14 will still be minimized since the inboard seal 50 and outboard seal 54 do not make deforming contact with the fluid element 16. Moreover, because the land of the main seal’s inboard tooth 68 has a larger inner diameter than the lands of its twin teeth 60, 62, the inboard tooth 68 will initiate deforming contact with the fluid element 16 after the twin teeth 60, 62 are set to help delay and minimize loading force for the drive ring 14. Nevertheless, in other examples, the torsion ridge 70 can initiate deforming contact with the fluid element 16 after the entire main seal 52 has been fully set to help further minimize loading force for the drive ring 14.

Engagement of the torsion ridge 70 with the fluid element 16 at an early stage of the installation process is preferable to prevent the sleeve 32 of the coupling body 12 from collapsing or sliding in the inboard direction D₂. That is, as the drive ring 14 slides axially along the sleeve 32, the sleeve 32 will experience axial force in the inboard direction D₂ that could cause it to axially collapse or slide. However, engagement of the torsion ridge 70 with the fluid element 16 will resist this axial force and prevent the distal end of the sleeve 32 from moving in the inboard direction D₂. In present embodiment, the torsion ridge 70 initiates deforming contact with the fluid element 16 after the main seal 52. However, in other examples, the torsion ridge 70 may be the first coupling element to initiate deforming contact with the fluid element 16.

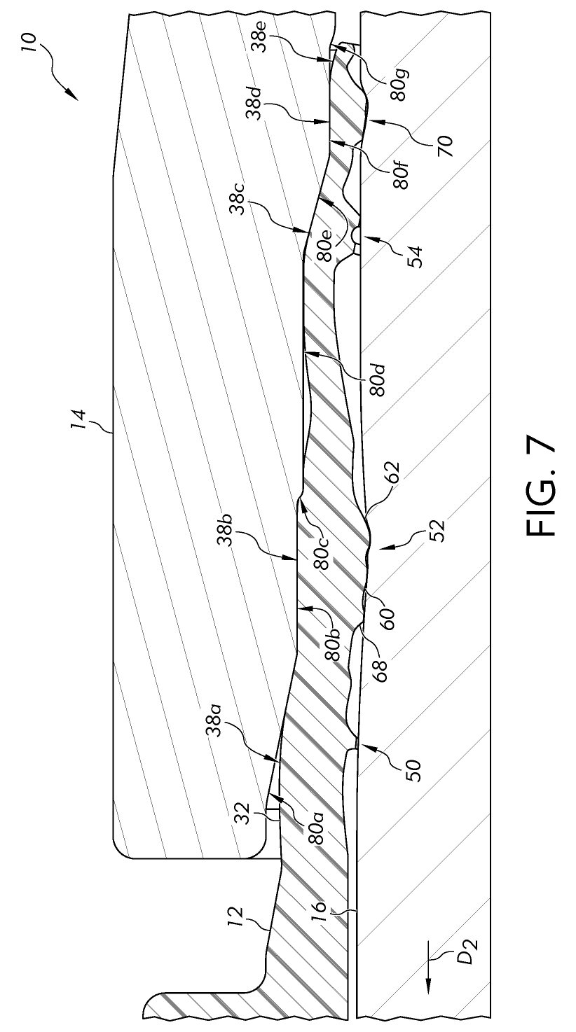

As the drive ring 14 continues axial movement in the inboard direction D₂, the fitting 10 will next assume the state shown in FIG. 7. Specifically, the tapered surface sections 80a, 80e of the drive ring 14 will respectively deflect the coupling body surface sections 38b, 38d (and the opposing main seal 52 and torsion ridge 70) radially inward such that they engage and pass under the diametrically constant surface sections 80b, 80f of the drive ring 14. Moreover, the tapered surface section 80e of the drive ring 14 will deflect the coupling body surface section 38c and opposing outboard seal 54 such that the outboard seal 54 initiates deforming contact with the fluid element 16, thereby initiating a setting process of the outboard seal 54. Because the coupling body surface sections 38b, 38d (and the opposing main seal 52 and torsion ridge 70) at this stage are radially aligned under the diametrically constant surface sections 80b, 80f of the drive ring 14, the main seal 52 and torsion ridge 70 will be fully set when the outboard seal 54 initiates setting into the fluid element 16, thereby minimizing loading force for the drive ring 14.

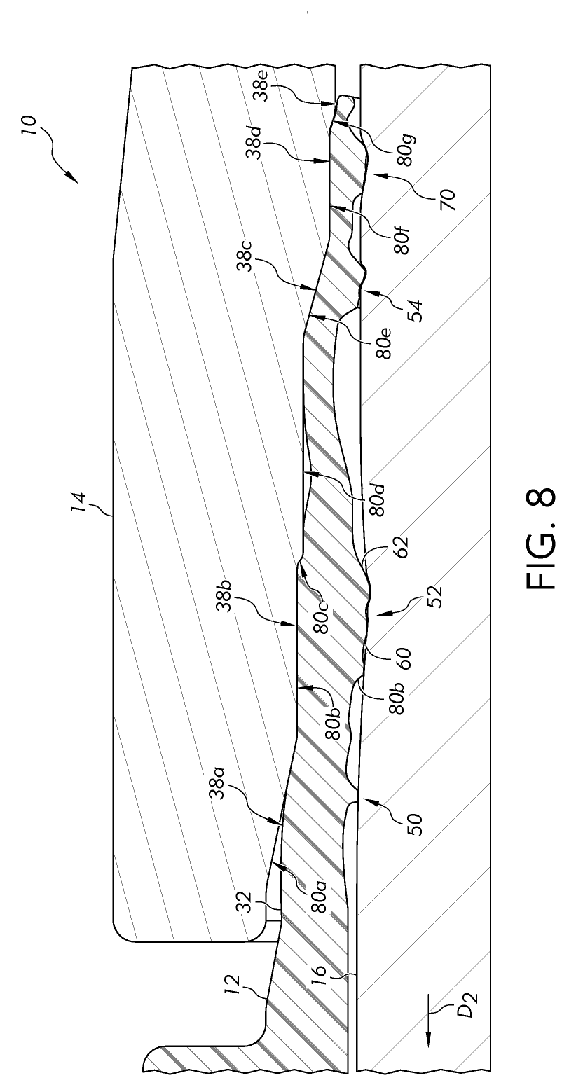

As the drive ring 14 continues axial movement in the inboard direction D₂, the fitting 10 will next assume the state shown in FIG. 8. Specifically, the tapered surface section 80a of the drive ring 14 will deflect the coupling body surface section 38a (and the inboard seal 50) radially inward such that the inboard seal 50 initiates deforming contact with the fluid element 16, thereby initiating a setting process for the inboard seal 50. In the present embodiment, the tapered surface section 80e of the drive ring 14 will continue deflecting the coupling body surface section 38c and opposing outboard seal 54 as the inboard seal 50 initiates deforming contact with the fluid element 16. In other words, setting of the outboard seal 54 will continue and overlap with setting of the inboard seal 52. However, the coupling body surface sections 38b, 38d (and the opposing main seal 52 and torsion ridge 70) will remain radially aligned under the diametrically constant surface sections 80b, 80f of the drive ring 14. Accordingly, the main seal 52 and torsion ridge 70 will remain set when the inboard seal 50 initiates setting into the fluid element 16, thereby minimizing loading force for the drive ring 14. Moreover, in other examples, the inboard seal 50 can initiate deforming contact with the fluid element 16 after the outboard seal 54 has been fully set to help further minimize loading force for the drive ring 14.

As the drive ring 14 continues axial movement in the inboard direction D₂, the fitting 10 will finally assume the installed configuration shown in FIG. 9. Specifically, the tapered surface sections 80a, 80e of the drive ring 14 will continue deflecting the coupling body surface sections 38a, 38c (and the inboard and outboard seals 50, 54) radially inward until the inboard and outboard seals 50, 54 fully set into the fluid element 16, thereby completing the setting process for the inboard and outboard seals 50, 54.

The drive ring 14 as described above is thus configured to radially contract various portions of the coupling body 12 to force each coupling element 50, 52, 54, 70 into the fluid element 16. In particular, the main seal 52 and torsion ridge 70 are set into the fluid element 16 before setting of the inboard and outboard seals 50, 54 begins. Simultaneous with the radial deflection of the coupling elements 50, 52, 54, 70, the drive ring 14 elastically expands radially outward. As a result, the setting of each coupling element 50, 52, 54, 70 by the drive ring 14 causes an incremental increase in the diameter of the drive ring 14. Moreover, the incremental diameter growth of the drive ring 14 caused by the inboard and outboard seals 50, 54 can have a small adverse effect on the previously set main seal 52 and torsion ridge 70 by reducing the compressive force that the drive ring 14 applies against those coupling elements 52, 90. Accordingly, the fitting 10 is preferably configured such that restoring loads are applied to the main seal 52 and torsion ridge 70 during the final stage of the drive ring’s axial movement.

More specifically, as the drive ring 14 moves from its position in FIG. 8 to the installed configuration shown in FIG. 9, the tapered surface sections 80c, 80g of the drive ring 14 will respectively deflect the coupling body surface sections 38b, 38d (and the opposing main seal 52 and torsion ridge 70) radially inward such that they engage and pass under the diametrically constant surface sections 80d, 80h of the drive ring 14. This radial deflection will compress and provide restoring loads to the main seal 52 and torsion ridge 70 to ensure proper engagement of those coupling elements 52, 70 with the fluid element 16.

The final compression of the main seal 52 and torsion ridge 70 by the tapered surface sections 80c, 80g of the drive ring 14 can also be referred to a “kickdown” of the main seal 52 and torsion ridge 70. In the present embodiment, the kickdown of the main seal 52 and torsion ridge 70 is initiated while the inboard and outboard seals 50, 54 are still setting. However, axial loading for the drive ring 14 will still be relatively low since the tapered surface sections 80c, 80g are relatively short and radially compress/deflect the main seal 52 and torsion ridge 70 a relatively minimal degree. Moreover, in other examples, the kickdown of the main seal 52 and/or torsion ridge 70 can be initiated after the inboard and outboard seals 50, 54 have been fully set to help further minimize loading force for the drive ring 14.

As assembled, the function of the main seal 52 is to substantially engage the fluid element 16 to provide a hermetic seal therewith so that no fluid flowing through the fluid element 16 can escape between the seal 52 and the fluid element 16. The inboard and outboard seals 50, 54 make at least a minimal bite into the outer surface of the fluid element 16 and also provide a barrier to the flow of fluid thereby. Moreover, the inboard and outboard seals 50, 54 function to prevent pivoting or rocking of the fluid element 16 about a fulcrum established where the main seal 52 bites into the fluid element 16. This prevents the fluid element 16 from bending or flexing about the main seal 52, thus inhibiting relative motion between the main seal 52 and the fluid element 16 and thus leakage at the point where the seal 52 engages the fluid element 16.

As a result of the above methodology, the main seal 52 and torsion ridge 70 initiate deforming contact with the fluid element 16, and then the inboard seal 50 and outboard seal 54 initiate deforming contact the fluid element 16. In the embodiment described above, the fitting 10 is configured such that main seal 52 initiates deforming contact with the fluid element 16 prior to the torsion ridge 70, and/or separately the outboard seal 54 initiates deforming contact with the fluid element 16 before the inboard seal 50, and fully sets into the fluid element 16 at about the same time as the inboard seal 50. However, in other examples, the torsion ridge 70 may initiate deforming contact with the fluid element 16 before the main seal 52, and/or separately the inboard seal 50 may initiate deforming contact with the fluid element 16 before the outboard seal 54 while still achieving similar results.

The invention has been described with reference to example embodiments. Obviously, modifications and alterations will occur to others upon reading and understanding the preceding detailed description. It is intended that the exemplary embodiments be construed as including all such modifications and alterations insofar as they come within the scope of the appended claims or the equivalents thereof.

What is claimed is:

1. A fluid fitting for mechanical attachment to a fluid element, comprising:
a coupling body defining a bore for receiving the fluid element therein, the coupling body comprising a main seal, an inboard seal, an outboard seal, and a torsion ridge; and
a drive ring configured to fit over the coupling body,
wherein the fluid fitting is configured to be installed on the fluid element by axially translating the drive ring over the coupling body with the fluid element inside the bore of the coupling body, thereby mechanically attaching said coupling body to the fluid element,
wherein the fluid fitting is configured such that during installation:
the main seal and torsion ridge initiate deforming contact with the fluid element, and then
the inboard seal and outboard seal initiate deforming contact the fluid element.

2. The fluid fitting according to claim 1, wherein the fluid fitting is configured such that during installation:
one of the main seal and torsion ridge initiates deforming contact with the fluid element after the other of the main seal and torsion ridge initiates deforming contact with the fluid element.

3. The fluid fitting according to claim 2, wherein the fluid fitting is configured such that during installation, the torsion ridge initiates deforming contact with the fluid element after the main seal initiates deforming contact with the fluid element.

4. The fluid fitting according to claim 1, wherein the fluid fitting is configured such that during installation:
one of the inboard seal and outboard seal initiates deforming contact with the fluid element after the other of the inboard seal and outboard seal initiates deforming contact with the fluid element.

5. The fluid fitting according to claim 4, wherein the fluid fitting is configured such that during installation, the inboard seal initiates deforming contact with the fluid element after the outboard seal initiates deforming contact with the fluid element.

6. The fluid fitting according to claim 1, wherein the fluid fitting is configured such that during installation, the outboard seal initiates deforming contact with the fluid element while the main seal and torsion ridge are set into the fluid element.

7. The fluid fitting according to claim 1, wherein the fluid fitting is configured such that during installation, the inboard seal initiates deforming contact with the fluid element while the main seal and torsion ridge are set into the fluid element.

8. The fluid fitting according to claim 1, wherein the fluid fitting is configured such that during installation:
the main seal initiates deforming contact with the fluid element, and then
the torsion ridge initiates deforming contact with the fluid element, and then
the outboard seal initiates deforming contact with the fluid element, and then
the inboard seal initiates deforming contact with the fluid element.

9. The fluid fitting according to claim 1, wherein the fluid fitting is configured such that during installation, the drive ring applies a first restoring load to the main seal and a second restoring load to the torsion ridge after the inboard seal and outboard seal initiate deforming contact with the fluid element.

10. The fluid fitting according to claim 1, wherein the coupling body comprises:
a first sleeve portion that forms the main seal, inboard seal, and outboard seal, and
a second sleeve portion located axially between the outboard seal and torsion ridge,
wherein a minimum thickness of the second sleeve portion is less than a minimum thickness of the first sleeve portion.

11. The fluid fitting according to claim 1, wherein the drive ring comprises an inner surface that defines a through hole for receiving the coupling body, the inner surface comprising:
a first tapered surface section that decreases in diameter in a distal direction,
a first diametrically constant surface section that extends from the first tapered surface section in the distal direction,
a second tapered surface section that decreases in diameter in the distal direction and is smaller in diameter than the first tapered surface section,
a second diametrically constant surface section that extends from the second tapered surface section in the distal direction and is smaller in diameter than the first diametrically constant surface section,
a third tapered surface section that decreases in diameter in the distal direction and is smaller in diameter than the second tapered surface section,
a third diametrically constant surface section that extends from the third tapered surface section in the distal direction and is smaller in diameter than the second diametrically constant surface section,
a fourth tapered surface section that decreases in diameter in the distal direction and is smaller in diameter than the third tapered surface section, and
a fourth diametrically constant surface section that extends from the fourth tapered surface section in the distal direction and is smaller in diameter than the third diametrically constant surface section.

12. The fluid fitting according to claim 1, wherein the coupling body comprises an inner surface that forms the main seal, inboard seal, outboard seal, and torsion ridge, and an outer surface opposite to the inner surface, the outer surface comprising:
a tapered surface section opposite to the inboard seal that increase in diameter in a distal direction,
a rounded section opposite to the main seal that includes an upsloping ramp and a downsloping ramp,
a first diametrically constant surface section opposite to the outboard seal, and
a second diametrically constant surface section opposite to the torsion ridge.

13. A method of installing the fluid fitting according to claim 1, the method comprising:
inserting fluid element within the bore of the coupling element such that the fluid element extends through the main seal, inboard seal, outboard seal, and torsion ridge, and
axially translating the drive ring over the coupling body with the fluid element inside the bore of the coupling body, wherein:
the main seal and torsion ridge initiate deforming contact with the fluid element, and then
the inboard seal and outboard seal initiate deforming contact the fluid element.

14. The method according to claim 13, wherein one of the main seal and torsion ridge initiates deforming contact with the fluid element after the other of the main seal and torsion ridge initiates deforming contact with the fluid element.

15. The method according to claim 14, wherein the torsion ridge initiates deforming contact with the fluid element after the main seal initiates deforming contact with the fluid element.

16. The method according to claim 13, wherein one of the inboard seal and outboard seal initiates deforming contact with the fluid element after the other of the inboard seal and outboard seal initiates deforming contact with the fluid element.

17. The method according to claim 13, wherein the outboard seal initiates deforming contact with the fluid element while the main seal and torsion ridge are set into the fluid element.

18. The method according to claim 13, the inboard seal initiates deforming contact with the fluid element while the main seal and torsion ridge are set into the fluid element.

19. The method according to claim 13, wherein:
the main seal initiates deforming contact with the fluid element, and then
the torsion ridge initiates deforming contact with the fluid element, and then
the outboard seal initiates deforming contact with the fluid element, and then
the inboard seal initiates deforming contact with the fluid element.

20. The method according to claim 13, wherein the drive ring applies a first restoring load to the main seal and a second restoring load to the torsion ridge after the inboard seal and outboard seal initiate deforming contact with the fluid element.
